(19) United States
(12) Patent Application Publication
(10) Pub. No.: US 2022/0134708 A1
(43) Pub. Date: May 5, 2022

(54) INFORMATION SECURITY PAPER

(71) Applicant: NAN YA PLASTICS CORPORATION, TAIPEI (TW)

(72) Inventors: TE-CHAO LIAO, TAIPEI (TW); CHING-YAO YUAN, TAIPEI (TW); Yu-Chi Hsieh, TAIPEI (TW)

(21) Appl. No.: 17/381,589

(22) Filed: Jul. 21, 2021

(30) Foreign Application Priority Data
Nov. 3, 2020 (TW) 109138150

(51) Int. Cl. B32B 15/12; B32B 27/10; B32B 15/085; B32B 15/20; B32B 15/18; B32B 27/32; B32B 27/36; B32B 27/34; B32B 15/088; B32B 15/09; B32B 3/26; G06K 19/07; G06K 19/077

(52) U.S. Cl. CPC B32B 15/12; B32B 2554/00; B32B 15/085; B32B 15/20; B32B 15/18; B32B 27/32; B32B 27/36; B32B 27/34; B32B 15/088; B32B 15/09; B32B 3/266; G06K 19/0723; G06K 19/07773; B32B 2307/5825; B32B 2307/558; B32B 2255/26; B32B 2255/12; B32B 27/10

(57) ABSTRACT

An information security paper is provided. The information security paper includes a first paper layer, a second paper layer, a sensing unit, and a plastic reinforcement layer. The sensing unit and the plastic reinforcement layer are both disposed between the first paper layer and the second paper layer, and the plastic reinforcement layer is located at one side of the sensing unit.

CROSS-REFERENCE TO RELATED PATENT APPLICATION

This application claims the benefit of priority to Taiwan Patent Application No. 109138150, filed on Nov. 3, 2020. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to an information security paper with sensing function, and more particularly to an information security paper that uses metal or electronic tags, and has the functions of both security paper and dust-proof paper.

### BACKGROUND OF THE DISCLOSURE

With the rapid advancement of technology, one of the ways for companies to make profits is to quickly grasp developmental trends and to develop products accordingly. However, in order to prevent the results of painstaking research from being leaked unexpectedly, technology companies usually implement a strict monitoring of circulation areas and channels of internal confidential information, so as to protect commercial secrets.

According to statistics, out of many cases of confidential information leakage, the manners in which confidential information is leaked can be roughly divided into network transmission (11.3%), hardware copy (13.1%), photocopying of documents (72.6%), and others (2.7%). Most companies can use security software to control the data flow of digital data (such as computer data and network packets), so as to prevent leakage of easily transmitted electronic data. However, monitoring circulation of hardcopy paper documents and ensuring information security can only be achieved by enhancing control of the documents or attaching electronic tags or barcodes to a paper surface.

In addition, if a researcher is negligent and takes confidential materials out of a regulated security area, anyone is likely to leak information, thereby causing the confidential materials to be unintentionally disclosed. Therefore, R&D departments in most companies use confidential security paper which can be marked by a special imprint or barcode, and can be detected by corresponding detection devices.

In this way, an area and range within which the confidential security paper circulates can be effectively controlled. Generally, technology companies set up detection devices at entrances and exits of specific areas. Once the detection device detects the imprint or barcode on the confidential security paper, the detection device will issue an audible warning to alert the relevant personnel, so as to prevent the confidential security paper from being taken out of the security area.

Further, such companies usually also uses a special confidential printer that has a built-in software or hardware with an identification function, for which only the confidential security paper that meets the specifications can be identified and printed. In this way, the paper that is used can be under full control, and the effect of protecting commercial secrets can be achieved.

According to the above, paper is still used as the material of the security paper in conventional technologies. However, the security paper made of paper generally has poor mechanical strength, is easily ripped or torn to pieces, and generates a high amount of dust so as to be unsuitable for use in clean rooms. Therefore, although the security paper in the conventional technologies has matured, the goal of research and development for those skilled in the art is still to develop a security paper that has good tear resistance and impact resistance, as well as a lower amount of paper dust.

### SUMMARY OF THE DISCLOSURE

In response to the above-referenced technical inadequacies, the present disclosure provides an information security paper, which not only has the anti-theft function, but also has good tear resistance and impact resistance.

In one aspect, the present disclosure provides an information security paper that includes a first paper layer, a second paper layer, a sensing unit, and a plastic reinforcement layer. The sensing unit and the plastic reinforcement layer are both disposed between the first paper layer and the second paper layer, and the plastic reinforcement layer is located at one side of the sensing unit.

In certain embodiments, the information security paper further includes a first protective layer and a second protective layer. The sensing unit, the plastic reinforcement layer, the first paper layer, and the second paper layer are disposed between the first protective layer and the second protective layer.

In certain embodiments, the first protective layer and the second protective layer both have a thickness between 0.5 μm and 20 μm. Each of a material of the first protective layer and a material of the second protective layer is at least one selected from the group consisting of polymethylmethacrylate (PMMA), polyvinyl alcohol (PVA), ethylene vinyl acetate (EVA), polyurethane (PU), and combinations thereof.

In certain embodiments, the sensing unit includes at least one metal material, and the at least one metal material is at least one selected from the group consisting of aluminum, copper, nickel, iron, and mixtures or alloys thereof.

In certain embodiments, the sensing unit has a layered structure, and at least one type of metal particle, at least one type of metal fiber, or a combination thereof dispersed in the layered structure.

In certain embodiments, the sensing unit is an electronic tag, which includes an antenna structure and a radio frequency identification chip coupled to the antenna structure.

In certain embodiments, a material of the plastic reinforcement layer is at least one selected from the group consisting of polyolefin, polyester, polyamide, and combinations thereof. Specifically speaking, the material of the plastic reinforcement layer is at least one selected from the group consisting of polyethylene, biaxially oriented polypropylene, cast polypropylene, cast polyethylene terephthalate, biaxially oriented ethylene terephthalate, and polyimide. In addition, the plastic reinforcement layer has a thickness between 9 μm and 50 μm.

In certain embodiments, according to a SEMI G67-0996 test, a quantity of particles having a particle size greater than 0.3 μm that are generated by the information security paper is between 50 and 1200 count/ft³.

In certain embodiments, the first protective layer and the second protective layer are formed on the first paper layer and the second paper layer by gravure coating, respectively.

Therefore, by virtue of “the sensing unit being disposed between the first paper layer and the second paper layer” and “the plastic reinforcement layer being disposed between the first paper layer and the second paper layer, and being located at one side of the sensing unit”, the information security paper provided by the present disclosure not only has the anti-theft function, but also has good tear resistance and impact resistance.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1 is a partial cross-sectional view of an information security paper according to a first embodiment of the present disclosure;

FIG. 2 is a partial cross-sectional view of the information security paper according to a second embodiment of the present disclosure;

FIG. 3 is a partial cross-sectional view of the information security paper according to a third embodiment of the present disclosure;

FIG. 4 is a partial top view of the information security paper according to a fourth embodiment of the present disclosure;

FIG. 5 is a schematic cross-sectional view taken along line V-V of FIG. 4; and

FIG. 6 is a partial cross-sectional view of the information security paper according to a fifth embodiment of the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a”, “an”, and “the” includes plural reference, and the meaning of “in” includes “in” and “on”. Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first”, “second” or “third” can be used to describe various components, signals or the like, which are for distinguishing one component/signal from another one only, and are not intended to, nor should be construed to impose any substantive limitations on the components, signals or the like.

### First Embodiment

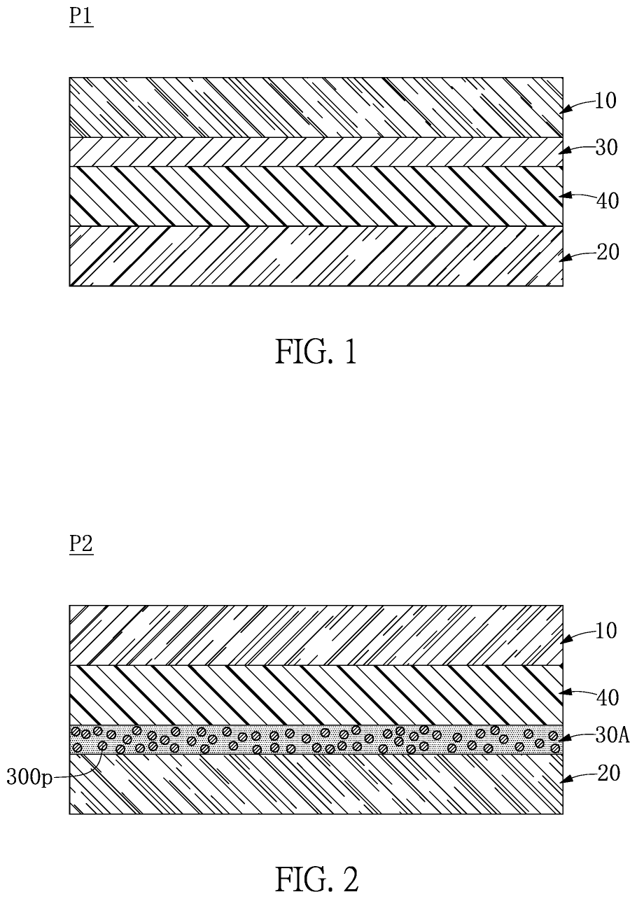

Referring to FIG. 1, a first embodiment of the present disclosure provides an information security paper P1. The information security paper P1 provided by the present disclosure can be applied to avoid leakage of confidential information. The information security paper P1 provided by the present disclosure can have the same appearance as plain paper, can have the A3 paper size (297 mm×420 mm) or A4 paper size (210 mm×297 mm), and can be copied by a special photocopying device. Further, compared with a conventional security paper, the information security paper P1 in the embodiment of the present disclosure has good tear resistance and impact resistance. In the embodiment of the present disclosure, the information security paper P1 has flexibility, and a thickness thereof can be adjusted in the range from 20 μm to 350 μm of according to different requirements.

Referring to FIG. 1, the information security paper P1 includes a first paper layer 10, a second paper layer 20, a sensing unit 30, and a plastic reinforcement layer 40. The plastic reinforcement layer 40 is located at one side of the sensing unit 30, and the sensing unit 30 and the plastic reinforcement layer 40 are both disposed between the first paper layer 10 and the second paper layer 20.

In certain embodiments, the materials used to produce the first paper layer 10 and the second paper layer 20 can include, but are not limited to, pulp, waste paper, wood fiber, and so on. The sensing unit 30 is embedded in the information security paper P1, so that the information security paper P1 can be identified by a specific detection device. In certain embodiments, the sensing unit 30 includes at least one metal material, and the at least one metal material is at least one selected from the group consisting of aluminum, copper, nickel, iron, and mixtures or alloys thereof. Therefore, the detection device corresponding to the sensing unit 30 may be a metal detector or an X-ray sensor. In certain embodiments, the metal material is a magnetic material, which can be a soft magnetic material or a hard magnetic material, but the present disclosure is not limited thereto.

Referring to FIG. 1, the sensing unit 30 of this embodiment has a layered structure. In other words, the sensing unit 30 of this embodiment is a metal sheet, and is sandwiched between the first paper layer 10 and the second paper layer 20. In an exemplary embodiment, the sensing unit 30 is an aluminum foil. Since metal has good ductility, a thickness of the metal sheet can be less than 10 μm. Therefore, even if the metal sheet is used in the information security paper P1 of the present disclosure, a total thickness thereof is almost the same as that of ordinary paper, thereby preventing any inconvenience of use and transportation due to being overly thick. In certain embodiments, the metal sheet has a thickness from 4 μm to 8 μm; preferably, the metal sheet has a thickness of 6 μm. However, the aforementioned embodiment is merely an example and is not meant to limit the scope of the present disclosure.

In certain embodiments, the metal sheet used as the sensing unit 30 may be formed to have a plurality of through holes, and the plurality of through holes are evenly distributed on the metal sheet. In this way, the information security paper P1 of the present disclosure can use less metal materials, but can still be recognized by the detection device. In certain embodiments, the metal sheet can have a specific pattern, which may include symbols, characters, numbers, or any combination thereof, and can be recognized by a specific detection device.

When a metal sheet formed to have through holes or a pattern is used as the sensing unit 30, not only can the material cost be reduced, but a total weight of the information security paper P1 can also be reduced. In addition, after the through holes or the pattern is formed, a contact area between the metal sheet and the paper layers (the first paper layer 10 or the second paper layer 20) and a contact area with the plastic reinforcement layer 40 will also increase accordingly, thereby enhancing the bonding between the sensing unit 30 and the plastic reinforcement layer 40 and the paper layers (the first paper layer 10 or the second paper layer 20). In certain embodiments, an adhesive may be used to bond the sensing unit 30 and the plastic reinforcement layer 40, so as to enhance the bonding between the sensing unit 30 and the plastic reinforcement layer 40.

In certain embodiments, the sensing unit 30 can include at least one type of metal particle, at least one type of metal fiber, or a combination thereof, which are mixed into the materials used to produce the first paper layer 10 and the second paper layer 20, so that the information security paper P1 can be identified by a specific detection device.

Appearance-wise, since the sensing unit 30 is not exposed from an outer surface of the information security paper P1, the appearance of the information security paper P1 provided by the embodiment of the present disclosure is the same as that of plain paper. Even if a person intends to steal or leak confidential information, the sensing unit 30 cannot be easily removed from the outside of the information security paper P1. Therefore, the information security paper P1 of the embodiment of the present disclosure can be used to prevent the leakage of confidential information relating to technology research and development.

Referring to FIG. 1, the plastic reinforcement layer 40 is located at one side of the sensing unit 30. In this embodiment, the plastic reinforcement layer 40 is located between the sensing unit 30 and the second paper layer 20. However, in other embodiments, the plastic reinforcement layer 40 can also be located between the sensing unit 30 and the first paper layer 10. That is, as long as the plastic reinforcement layer 40 and the sensing unit 30 are both sandwiched between the first paper layer 10 and the second paper layer 20, there is no limitation on the position of the plastic reinforcement layer 40 in the present disclosure.

The plastic reinforcement layer 40 can be used to strengthen the mechanical strength of the information security paper P1, so that the information security paper P1 has better tear resistance and impact resistance. If the plastic reinforcement layer 40 is too thin, the tear resistance of the information security paper P1 cannot be effectively improved. If the plastic reinforcement layer 40 is too thick, the information security paper P1 will be too heavy. In certain embodiments, the plastic reinforcement layer 40 has a thickness between 9 μm and 50 μm.

In addition, the material of the plastic reinforcement layer 40 is at least one selected from the group consisting of polyolefin, polyester, polyamide, and combinations thereof. For instance, the material of the plastic reinforcement layer 40 is at least one selected from the group consisting of polyethylene, biaxially oriented polypropylene, cast polypropylene (CPP), cast polyethylene terephthalate (cast PET), biaxially oriented ethylene terephthalate, and polyimide.

The polyethylene can be an ethylene homopolymer, an ethylene copolymer, or a mixture thereof. The ethylene homopolymer refers to a polymer polymerized by using only ethylene as a monomer, and the ethylene homopolymer has a dispersion degree from 1.5 to 3.5. The dispersion degree here refers to a ratio of a weight average molecular weight to a number average molecular weight, which may be abbreviated as Mw/Mn. The ethylene copolymer refers to a copolymer formed by the co-polymerization of ethylene and another or multiple other monomers, and the ethylene copolymer has a dispersion degree of 3.5 or more. However, the present disclosure is not limited thereto.

In certain embodiments, an adhesive layer (not shown) is provided between the plastic reinforcement layer 40 and the sensing unit 30. The adhesive layer can be formed by mixing aqueous polyurethane and acrylic resin. The content of the aqueous polyurethane in the adhesive layer is from 1% to 70% by weight, and the content of the acrylic resin is from 1% to 70% by weight, but the present disclosure is not limited thereto.

When the sensing unit 30 is a metal sheet, since the sensing unit 30 and the plastic reinforcement layer 40 are made of different materials, the bonding therebetween is poor. Therefore, before bonding the sensing unit 30 (metal sheet) and the plastic reinforcement layer 40, a primer with a thickness from about 1 μm to 5 μm can be coated on the surface of the sensing unit 30, so that an adhesive layer is formed between the sensing unit 30 and the plastic reinforcement layer 40, which allows the bonding between the sensing unit 30 and the plastic reinforcement layer 40 to be improved. In this embodiment, the adhesive layer has a thickness of 2 μm, but the present disclosure is not limited thereto.

Accordingly, the information security paper P1 provided by the embodiment of the present disclosure has better tear resistance and impact resistance, and can be used to avoid leakage of confidential information.

Reference is made to FIG. 2, which is a partial cross-sectional view of the information security paper according to a second embodiment of the present disclosure. In this embodiment, components of an information security paper P2 that are the same as those of the first embodiment have the same reference numerals, and the same parts will not be reiterated herein.

Specifically, a sensing unit 30A of the information security paper P2 of this embodiment is a composite material layer, which includes an organic material and at least one type of metal particle 300p. The material of the metal particles 300p is at least one selected from the group consisting of aluminum, copper, nickel, iron, and mixtures or alloys thereof. In other words, the sensing unit 30A has a layered structure, and the metal particles 300p are dispersed in the layered structure. In certain embodiments, the metal particles 300p may only be distributed in a partial area of the composite material layer. Further, in this embodiment, the plastic reinforcement layer 40 is located between the sensing unit 30 and the first paper layer 10.

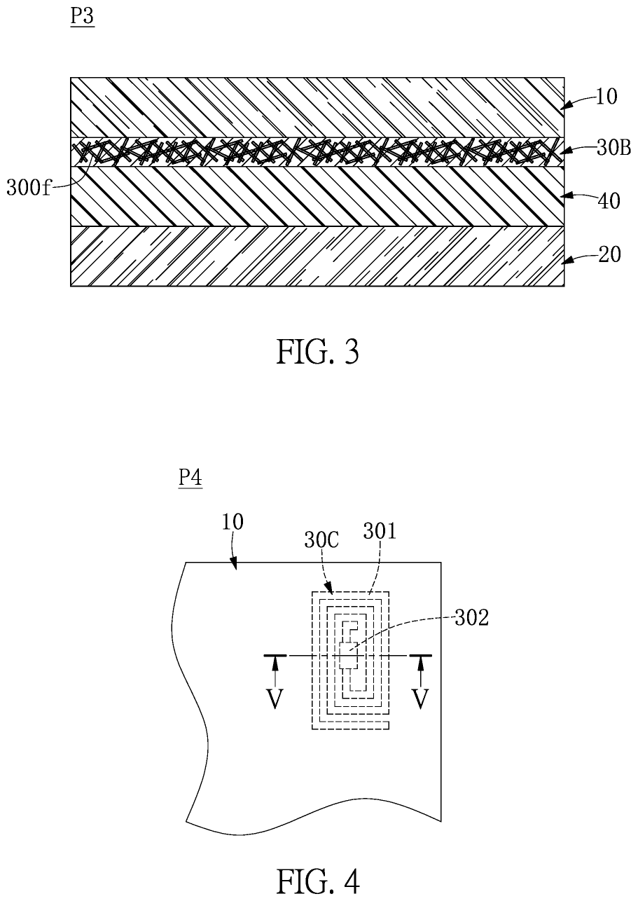

Reference is made to FIG. 3, which is a partial cross-sectional view of the information security paper according to a third embodiment of the present disclosure. In this embodiment, components of an information security paper P3 that are the same as those of the second embodiment have the same reference numerals. In this embodiment, the sensing unit 30B also has a layered structure and is a composite material layer, which includes an organic material and at least one type of metal fiber 300f. In other words, the metal fibers 300f are dispersed in the layered structure. Similar to the second embodiment, the material of the metal fibers 300f is at least one selected from the group consisting of aluminum, copper, nickel, iron, and mixtures or alloys thereof, but the present disclosure is not limited thereto.

In some embodiments, the sensing unit 30B can simultaneously have at least one type of metal particle 300p and at least one type of metal fiber 300f dispersed in the layered structure. As long as the sensing unit 30B can be detected by a specific detection device, a configuration of the sensing unit 30B is not limited by the present disclosure.

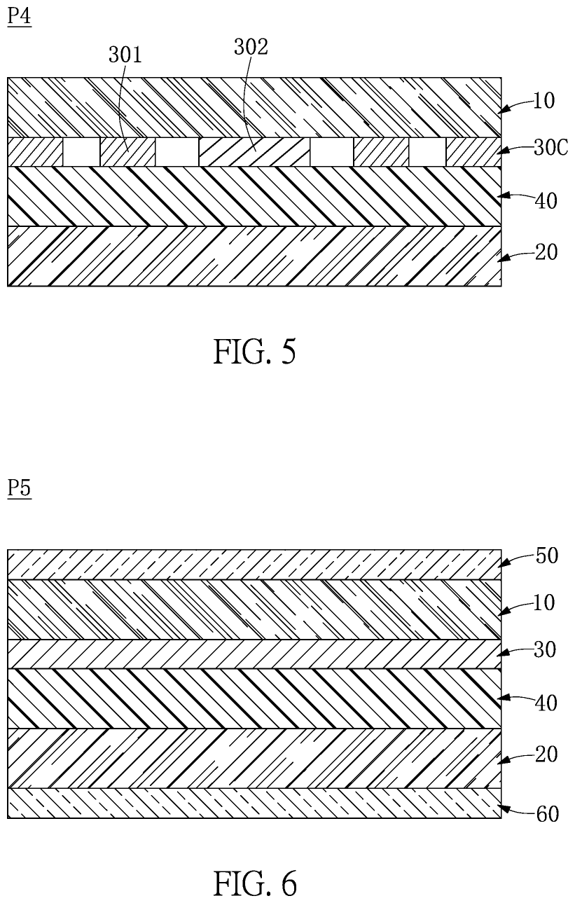

Referring to FIG. 4 and FIG. 5, FIG. 4 is a partial top view of an information security paper P4 according to a fourth embodiment of the present disclosure, and FIG. 5 is a schematic cross-sectional view taken along line V-V of FIG. 4.

Referring to FIG. 4, in the information security paper P4 of this embodiment, a sensing unit 30C is an electronic tag. Further, in certain embodiments, the electronic tag is a radio frequency identification tag, which can be a passive, semi-passive or active radio frequency identification tag. In this embodiment, the electronic tag includes an antenna structure 301 and a chip 302 coupled to the antenna structure 301, but the present disclosure is not limited thereto. In other embodiments, the chip 302 in the electronic tag can be omitted, and only the antenna structure 301 is provided.

The antenna structure 301 and the chip 302 can be formed on the plastic reinforcement layer 40, and be sandwiched between the first paper layer 10 and the second paper layer 20. With use of a special detection device, the data stored in the electronic tag can be read.

It should be noted that fibers on a surface of the plain paper are prone to generate dust after being rubbed. More specifically, according to the measurement of an air particle counter, after the plain paper is rubbed, a quantity of particles that have a particle size greater than 03 μm is more than 1500 count/ft³. In contrast, by having better tear resistance and impact resistance, the information security paper P1˜P4 provided by the present disclosure has a lower dust count, and can thus be used in general environments and even environments with strict requirements for cleanliness.

However, for a higher-level clean room, an amount of dust from the information security paper needs to be further reduced. Reference is made to FIG. 6, which is a partial cross-sectional view of an information security paper P5 according to a fifth embodiment of the present disclosure.

In order to be applicable to clean rooms with stricter grade specifications, in addition to the first paper layer 10, the second paper layer 20, the sensing unit 30, and the plastic reinforcement layer 40, the information security paper P5 of the embodiment of the present disclosure further includes a first protective layer 50 and a second protective layer 60.

Referring to FIG. 6, the first protective layer 50 and the second protective layer 60 are located on an outermost side of the information security paper P5. In other words, the sensing unit 30, the plastic reinforcement layer 40, the first paper layer 10 and the second paper layer 20 are all disposed between the first protective layer 50 and the second protective layer 60.

In certain embodiments, the material of the first protective layer 50 and the second protective layer 60 can be at least one selected from the group consisting of polymethylmethacrylate (PMMA), polyvinyl alcohol (PVA), ethylene vinyl acetate (EVA), polyurethane (PU), and combinations thereof. In certain embodiments, the first protective layer 50 and the second protective layer 60 are formed on the first paper layer 10 and the second paper layer 20 by gravure coating, respectively. In addition, the first protective layer 50 (or the second protective layer 60) has a thickness between 0.5 μm and 20 μm.

In this way, the information security paper P5 of this embodiment can greatly reduce the amount of dust generated after being rubbed, and can be used in clean rooms with higher grade specifications. More specifically, according to SEMI G67-0996 test, a quantity of particles larger than 0.3 μm produced by the information security paper P5 of this embodiment does not exceed 1500 count/ft³, and is preferably from 50 to 1200 count/ft³. In addition, the test results show that a quantity of particles that have a particle size greater than or equal to 0.5 μm is from 142 to 716 count/ft³, and a quantity of particles that have a particle size greater than or equal to 1 μm is from 84 to 403 count/ft³.

In addition, it should be noted that although the sensing unit 30 of this embodiment is the same as the sensing unit in the embodiment of FIG. 1, in other embodiments, it can also be arbitrarily replaced by the sensing units 30A-30C of FIGS. 2 to 4.

[Beneficial Effects of the Embodiments]

In conclusion, by virtue of “the sensing unit 30, 30A˜30C being disposed between the first paper layer 10 and the second paper layer 20” and “the plastic reinforcement layer 40 being disposed between the first paper layer 10 and the second paper layer 20, and being located at one side of the sensing unit 30, 30A˜30C”, the information security paper P1˜P5 provided by the present disclosure not only has the anti-theft function, but also has good tear resistance and impact resistance.

Further, compared with a comparative example that does not include the plastic reinforcement layer 40, the tear resistance of the information security paper P1˜P5 of the embodiment of the present disclosure is 1.5 to 3 times that of the comparative example. Due to the enhanced tear resistance and impact resistance, the information security papers P1˜P5 of the embodiments of the present disclosure are less likely to be torn and generate dust or fines, and can thus be used in clean rooms with higher grade specifications. As a whole, according to SEMI G67-0996 test, the quantity of particles larger than 0.3 μm produced by the information security paper P1˜P5 is between 50 and 1200 count/ft³.

Furthermore, the surface of the information security paper P1˜P5 of the embodiments of the present disclosure is less likely to produce fine dust after being rubbed, which can prevent fine dust from settling on equipment or production lines and affecting operation of the equipment or product production. When a researcher carries the information security paper P1˜P5 that contains research secrets and passes through the detection device, the detection device can recognize the sensing unit and emit a warning sound to alert the researcher, thereby achieving the purpose of protecting commercial secrets.

Moreover, the information security paper P5 of the embodiment of the present disclosure further includes a first protective layer 50 and a second protective layer 60 formed on the first paper layer 10 and the second paper layer 20, respectively. In this way, the dust generated by rubbing the surface of the information security paper P5 is further reduced, so that the information security paper P5 can be used in a higher-level clean room.

Compared with a conventional paper layer, the information security paper P1˜P5 of the embodiment of the present disclosure can be identified by the detection device, and the theft of confidential information can be avoided. In addition, by having low dust generation and high tear resistance and impact resistance, the information security paper P1˜P5 can be written and copied in environments with stricter cleanliness requirements.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. An information security paper, comprising:
a first paper layer;
a second paper layer;
a sensing unit disposed between the first paper layer and the second paper layer; and
a plastic reinforcement layer disposed between the first paper layer and the second paper layer, and located at one side of the sensing unit.

2. The information security paper according to claim 1, further comprising a first protective layer and a second protective layer, wherein the sensing unit, the plastic reinforcement layer, the first paper layer, and the second paper layer are disposed between the first protective layer and the second protective layer.

3. The information security paper according to claim 2, wherein the first protective layer and the second protective layer both have a thickness between 0.5 μm and 20 μm.

4. The information security paper according to claim 2, wherein each of a material of the first protective layer and a material of the second protective layer is at least one selected from the group consisting of polymethylmethacrylate (PMMA), polyvinyl alcohol (PVA), ethylene vinyl acetate (EVA), polyurethane (PU), and combinations thereof.

5. The information security paper according to claim 1, wherein the sensing unit includes at least one metal material, and the at least one metal material is at least one selected from the group consisting of aluminum, copper, nickel, iron, and mixtures or alloys thereof.

6. The information security paper according to claim 1, wherein the sensing unit has a layered structure, and at least one type of metal particle, at least one type of metal fiber, or a combination thereof is dispersed in the layered structure.

7. The information security paper according to claim 1, wherein the sensing unit is an electronic tag, which includes an antenna structure and a chip coupled to the antenna structure.

8. The information security paper according to claim 1, wherein a material of the plastic reinforcement layer is at least one selected from the group consisting of polyolefin, polyester, polyamide, and combinations thereof.

9. The information security paper according to claim 1, wherein the plastic reinforcement layer has a thickness between 9 μm and 50 μm.

10. The information security paper according to claim 1, wherein, according to a SEMI G67-0996 test, a quantity of particles having a particle size greater than 0.3 μm that are generated by the information security paper is between 50 and 1200 count/ft³.

11. The information security paper according to claim 1, wherein the first protective layer and the second protective layer are formed on the first paper layer and the second paper layer by gravure coating, respectively.

12. The information security paper according to claim 1, wherein a material of the plastic reinforcement layer is at least one selected from the group consisting of polyethylene, biaxially oriented polypropylene, cast polypropylene, cast polyethylene terephthalate, biaxially oriented ethylene terephthalate, and polyimide.
